(19) United States
(12) Patent Application Publication
(10) Pub. No.: US 2025/0019155 A1
(43) Pub. Date: Jan. 16, 2025

(54) AUTOMOTIVE SURGE TANK WITH SUBMERGED SWIRL CHAMBER

(71) Applicant: ABC TECHNOLOGIES, INC.

(72) Inventors: Richard ALLAN, Holland Landing (CA); Jerzy Czechowski, Toronto (CA)

(21) Appl. No.: 18/706,919

(22) PCT Filed: Nov. 4, 2022
(86) PCT No.: PCT/CA2022/051632

§ 371 Date: May 2, 2024

Related U.S. Application Data
(60) Provisional application No. 63/276,039, filed on Nov. 5, 2021.
(60) Provisional application No. 63/291,513, filed on Dec. 20, 2021.

(51) Int. Cl. B65D 88/54; B60K 11/02

(52) U.S. Cl. CPC B65D 88/54; B60K 11/02

(57) ABSTRACT

Provided is an automotive surge tank. The surge tank comprises a tank body defining an interior volume, the tank body including a first tank portion and a second tank portion, the surge tank also having a coolant inlet and a coolant outlet provided on the tank body. The interior volume of the tank body is subdivided into an inlet chamber, and outlet chamber, and at least one intermediate chamber, the surge tank being configured to direct an inflow of coolant into the inlet chamber at a level that is below the minimum operable fluid level of the surge tank.

### FIELD

The present invention relates to the field of automotive fluid reservoirs, and in particular to an automotive coolant surge tank that incorporates a submersed swirl chamber.

### BACKGROUND

Automotive coolant systems have long been a standard system component in automotive construction, in particular with respect to internal combustion engine vehicles. The coolant system serves to maintain the engine within a certain operational temperature range, while also providing thermal energy to the vehicles HVAC ventilation system.

With the shift in the industry towards Hybrid Electric Vehicles (HEVs), Partial Hybrid Electric Vehicles (PHEV) and Battery Electric Vehicles (BEV), new design and performance challenges are encountered with respect to thermal management, of both the propulsion and cabin ventilation systems. For example, for vehicles employing battery power as a primary or supplemental power source, the associated electrical systems operate at much lower temperatures compared to internal combustion engines, therein making less thermal energy available for cabin ventilation systems. Battery-based systems are also known to work within narrow temperature ranges, meaning the associated cooling systems must be reactive to the heating/cooling requirements depending on ambient conditions. The cooling system complexity has increased considerably, with systems now including multiple heating and cooling circuits, with advanced control systems.

In order to meet the demands of modern automotive coolant systems, additional efficiencies need to be built into the coolant system components. A particularly important component to the automotive coolant system is the surge tank. The coolant surge tank serves as a coolant reserve, as well as a means of allowing for coolant thermal expansion. In addition, the surge tank serves to de-aerate the coolant, thereby increasing the thermal efficiency of the coolant in the remainder of the cooling system. Therefore, it is often desirable to implement fluid flow characteristics into surge tank design to achieve enhanced de-aeration performance.

### SUMMARY

According to an aspect of an embodiment, provided is an automotive surge tank. The surge tank comprises a tank body defining an interior volume, the tank body including a first tank portion and a second tank portion, the surge tank also having a coolant inlet and a coolant outlet provided on the tank body. The interior volume of the tank body is subdivided into an inlet chamber, and outlet chamber, and at least one intermediate chamber, the surge tank being configured to direct an inflow of coolant into the inlet chamber at a level that is below the minimum operable fluid level of the surge tank.

According to another aspect of an embodiment, provided is an automotive surge tank. The surge tank comprises a tank body defining an interior volume, the tank body including a first tank portion and a second tank portion, the surge tank also having a coolant inlet and a coolant outlet provided on the tank body. The interior volume of the tank body is subdivided into an input chamber, and output chamber, and at least one intermediate chamber, the surge tank being configured to direct an inflow of coolant into an inlet sub-chamber below the minimum operable fluid level.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 illustrates a perspective view of a surge tank according to a first embodiment of the invention.

FIG. 2 illustrates a side view of the surge tank according to the embodiment of FIG. 1.

FIG. 3 illustrates a top view of the surge tank according to the embodiment of FIG. 1.

FIG. 4 illustrates a side sectional view of the surge tank according to the embodiment of FIG. 1, taken along the line A-A noted in FIG. 3.

FIG. 5 illustrates a top sectional view of the surge tank according to the embodiment of FIG. 1, taken along the line B-B noted in FIG. 2.

FIG. 6 illustrates a partial exploded view of the surge tank according to the embodiment of FIG. 1, with the first tank portion shown rotated relative to the second tank portion, to highlight interior features thereof.

FIG. 7 illustrates a top view of the second tank portion of the surge tank according to the embodiment of FIG. 1, to illustrates the swirl effect generated in the input chamber.

FIG. 8 illustrates a top view of the second tank portion of a second embodiment of the surge tank, to illustrate the swirl effect generated in the input chamber having a contoured impingement wall.

FIG. 9 illustrates a top view of the second tank portion of a third embodiment of the surge tank, incorporating an inlet extension within the input chamber.

FIG. 10 illustrates a perspective view of the second tank portion according to the embodiment of FIG. 9, detailing additional aspects of the modified input chamber.

FIG. 11 illustrates a partial exploded view of the surge tank according to a fourth embodiment including an inlet sub-chamber, with the first tank portion shown rotated relative to the second tank portion, to highlight interior features thereof.

FIG. 12 illustrates a sectional view of the surge tank according to the embodiment of FIG. 11, detailing aspects of the inlet sub-chamber.

FIG. 13 illustrates an alternate sectional view of the second tank portion of the surge tank according to the embodiment of FIG. 11, detailing aspects of the inlet.

FIG. 14 illustrates a partial exploded view of the surge tank according to a fifth embodiment including an alternative inlet sub-chamber, with the first tank portion shown rotated relative to the second tank portion, to highlight interior features thereof.

### DETAILED DESCRIPTION

Specific embodiments of the present invention will now be described with reference to the figures, wherein like reference numbers indicate identical or functionally similar elements. The following detailed description is merely exemplary in nature and is not intended to limit the disclosure or the application and uses of the disclosure. A person skilled in the relevant art will recognize that other configurations and arrangements can be used without departing from the scope of the disclosure. Furthermore, there is no intention to be bound by any expressed or implied theory presented in the preceding technical field or the following detailed description.

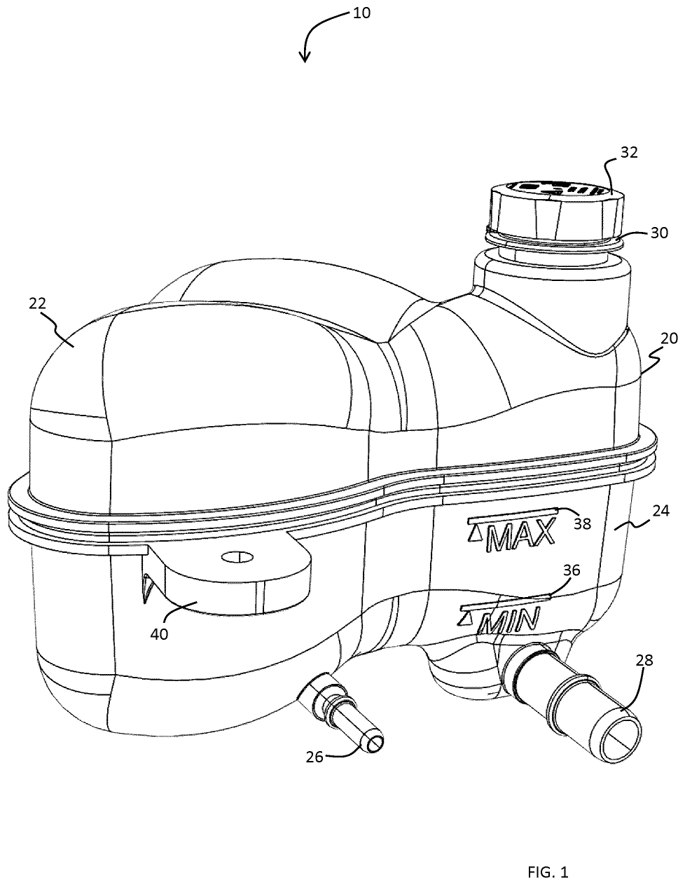

Turning now to FIGS. 1, 2, and 3, shown is an automotive surge tank 10 suitable for use in a cooling system as typically found in relation to an internal combustion engine. The surge tank 10 (also referred to in the automotive arts as an expansion tank or a coolant reservoir) includes a body 20 that defines an interior volume. The interior volume is configured to hold a select volume of engine coolant according to operational parameters of the engine in question. In the embodiment shown, the body 20 is defined by a first tank portion 22, and a second tank portion 24. The first and second tank portions 22, 24 are separately formed and assembled into an operable fluid-retainable configuration.

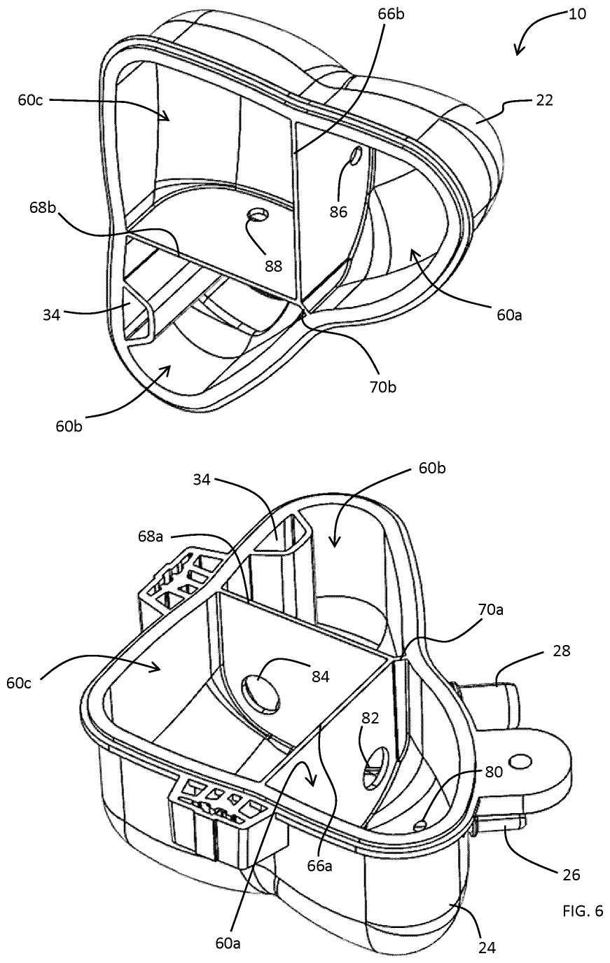

The body 20 includes an inlet 26 to receive coolant fluid into the interior volume, and an outlet 28 to release coolant fluid therefrom. By virtue of the inlet 26 and the outlet 28, the surge tank 10 may form part of a closed fluid loop, for example as would be found in an automotive coolant system. The body 20 also includes a fill port 30 to permit for filling/emptying of the surge tank 10 as needed. The area of the body 20 having the fill aperture 30 may be provided with a threaded or bayonet-style interface to receive a closure 32 (i.e. a radiator-style pressure cap). Pressure caps are known in the art, and generally provide an internal valve arrangement (i.e. a spring loaded disc valve) that opens to permit the venting of fluid from the vessel when the pressure exceeds a predefined threshold. The pressure cap 32 is generally configured to cooperate with a fluid release passage 34 (see FIG. 6), which may be an integrally formed conduit that directs vented fluid to an area below the body 20. In other arrangements, the pressure cap may be configured to release the vented fluid directly, generally to an area on top of the body 20. To assist in determining and ensuring the coolant system has the correct amount of coolant fluid in the system, fluid level indicators are provided on the body 20. As shown, the body 20 includes a minimum level indicator 36, and a maximum level indicator 38. The coolant reservoir 10 is generally mounted within the engine compartment or other area of the vehicle where the operator has access to the fill port 30 and closure 32. To facilitate mounting, the surge tank 10 may be provided with various mounting features. For example, the surge tank 10 may include at least one mount post 40, and at least one bracket post 42.

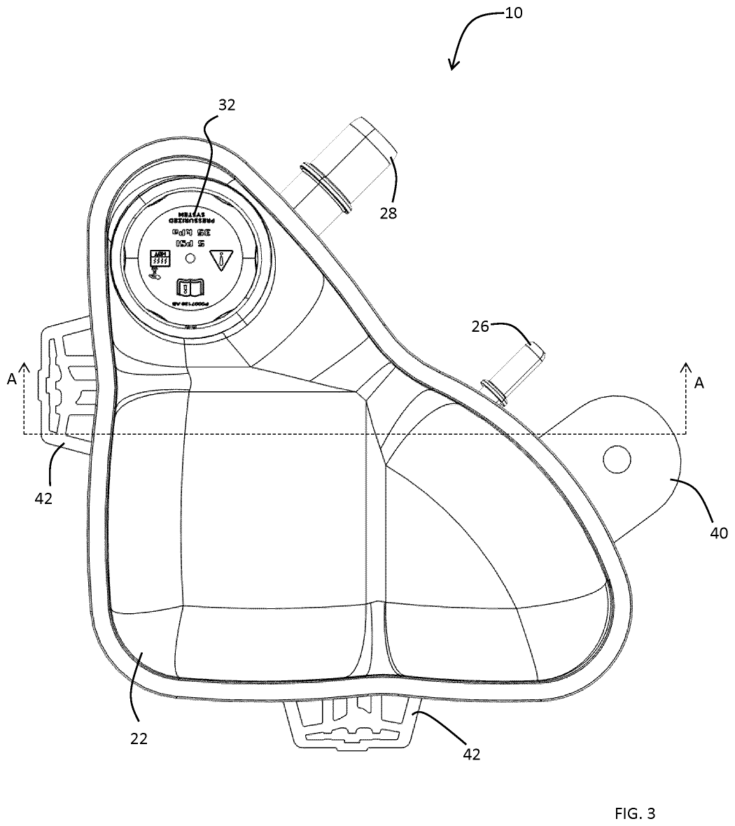

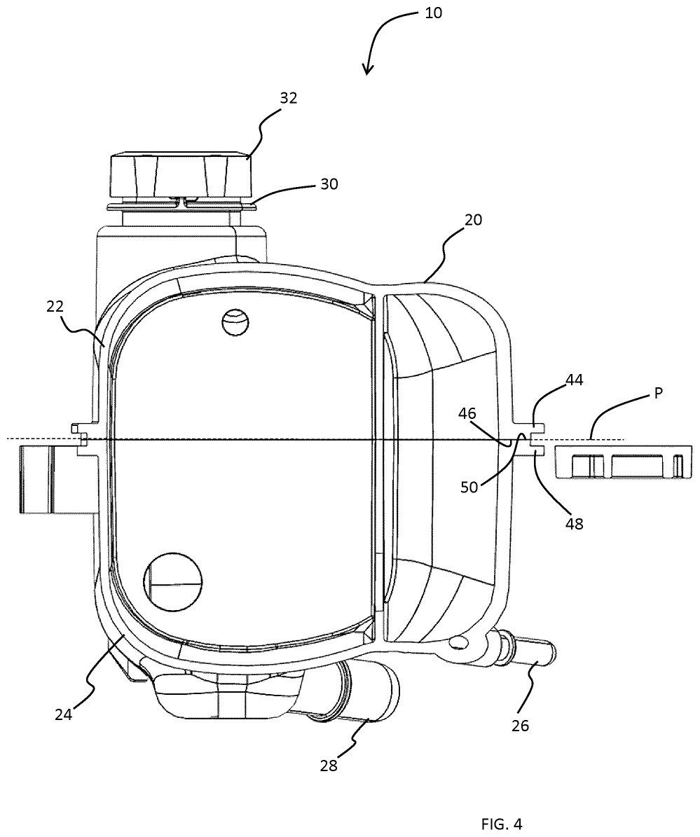

FIG. 4 depicts the surge tank 10 in cross-section through line A-A (shown in FIG. 3). The separately formed first and second tank portions 22, 24 that cooperatively define the tank body 20 are clearly shown. The first tank portion 22 provides a circumferential flange 44 having a first portion contact surface 46, while the second tank portion 24 similarly provides a circumferential flange 48 having a second portion contact surface 50. In the assembled state, the first and second portion contact surfaces 46, 50 are bonded, welded or otherwise joined along an assembly plane P to form the tank body 20.

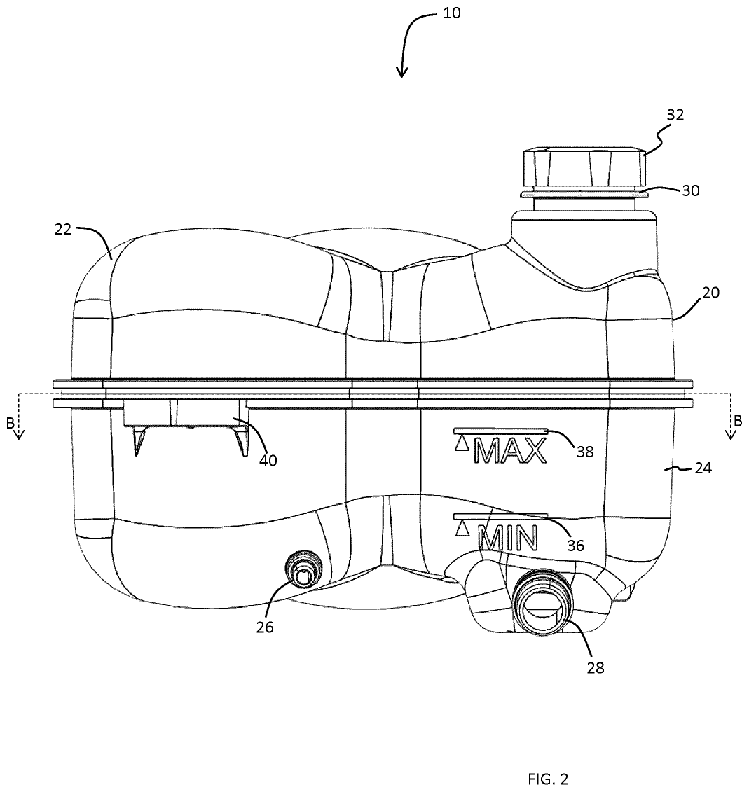

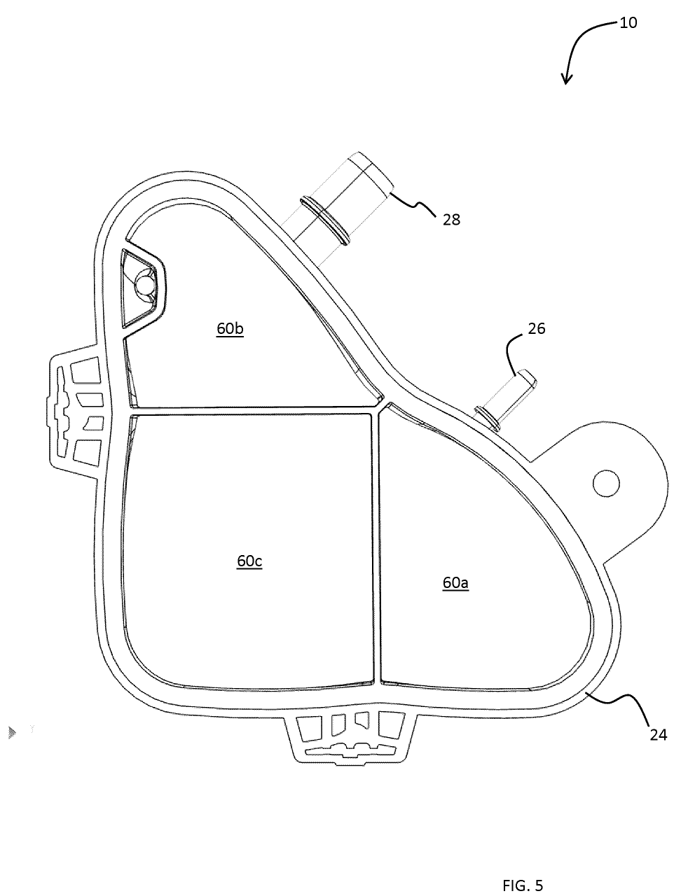

The interior volume of the tank body 20 is subdivided into chambers. FIG. 5 depicts the surge tank in simplified cross-section through line B-B (shown in FIG. 2). As shown, the interior volume is subdivided into 3 chambers, namely an input chamber 60a, an output chamber 60b, and an intermediate chamber 60c (collectively referred to as the interior chambers 60).

With reference now to FIG. 6, additional details on the arrangement of the interior chambers 60 is shown, with the first tank portion 22 shown rotated relative to the second tank portion 24, to highlight interior features thereof more clearly. Each of the interior chambers 60 is delineated by at least a portion of the first and second tank portions 22, 24 of the tank body 20, and an interior wall structure that extends from a base region of the second tank portion 24, to a top region of the first tank portion 22. With specific reference to the input chamber 60a, the lower portion thereof is shown to be delineated by a portion of the second tank portion 24, a first interior wall segment 66a and a third interior wall segment 70a, while the upper portion thereof is shown to be delineated by a portion of the first tank portion 22, a first interior wall segment 66b and a third interior wall segment 70b. The output chamber 60b is similarly configured where the lower portion thereof is shown to be delineated by a portion of the second tank portion 24, a second interior wall segment 68a and the third interior wall segment 70a, while the upper portion thereof is shown to be delineated by a portion of the first tank portion 22, a second interior wall segment 68b and the third interior wall segment 70b. Lastly, the intermediate chamber 60c is shown with a lower portion that is delineated by a portion of the second tank portion 24, the first interior wall segment 66a and the second interior wall segment 68a, while the upper portion thereof is shown to be delineated by a portion of the first tank portion 22, the first interior wall segment 66b and the second interior wall segment 68b. Similar to the first and second portion contact surfaces 46, 50 of the first and second tank portion 22, 24, each of the first interior wall segments 66a, 66b, the second interior wall segments 68a, 68b, and the third interior wall segments 70a, 70b are bonded, welded or otherwise joined in the process of forming the tank body 20. As shown, the upper and lower wall sections for each of the first, second and third interior wall segments 66, 68, 70 meet along the assembly plane P.

During use, coolant flows through the surge tank 10 by first flowing into the input chamber 60a, followed by the intermediate chamber 60c, and finally through the output chamber 60b. Continuing with FIG. 6, the input chamber 60a is configured to receive an inflow of coolant from the inlet 26 through an inlet port 80. The coolant circulates in the input chamber 60a, with a portion being discharged into the intermediate chamber 60c through a hole or slot provided in the first interior wall segment 66a. As shown, the first interior wall segment 66a includes a fluid passage hole 82, located below the minimum operable fluid level. The coolant then circulates in the intermediate chamber 60c, with a portion being discharged into the output chamber 60b through a hole or slot provided in the second interior wall segment 68a. As shown, the second interior wall segment 68a includes a fluid passage hole 84, located below the minimum operable fluid level. From the output chamber 60b, coolant is discharged back into the coolant loop via the outlet 28 through an outlet port 90. To ensure pressure equilibration between the 3 chambers 60, the first interior wall segment 66b includes a vent hole 86 located above the maximum operable fluid level, while the second interior wall segment 70b includes a vent hole 88 located above the maximum operable fluid level.

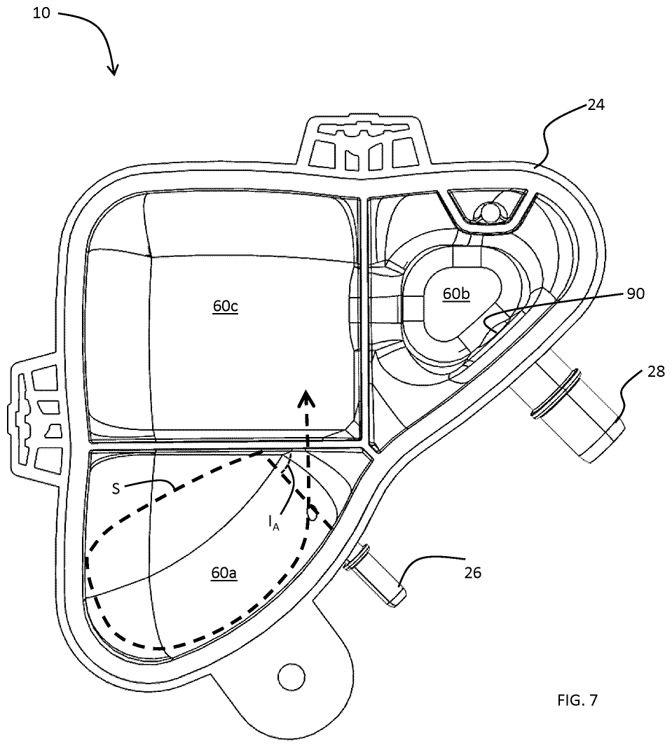

With reference now to FIG. 7, aspects of the coolant flow through the surge tank 10, and in particular through the input chamber 60a will be discussed. As previously shown, the inlet 26 that directs the flow of coolant into the input chamber 60a is located below the minimum operable fluid level. As such, the inflow of coolant into the input chamber 60a is directly into the liquid phase within the surge tank 10. To promote the purging of entrapped gases from the liquid phase, the inlet 26 is arranged to deliver the incoming coolant stream at an angle relative to the first surface it impinges upon, in this case the first interior wall segment 66a. As shown, the impingement angle IA is approximately 45°. As such, this initiates a rotational flow through the input chamber 60a, creating a swirling action (noted by arrow S) to promote the dissipation of energy, and the separation of entrapped gases. Impingement upon and deflection away from the first interior wall segment 66a directs the inbound flow of coolant around the wall surface of the second tank portion 24, with a portion of the coolant being discharged into the intermediate chamber 60c. It will be appreciated that the impingement angle of 45° is exemplary, and other impingement angles both above and below this value may be selected based on the desired swirling action, and the overall geometry of the input chamber 60a. For instance, impingement angles of 20, 25, 30, 35, 40, 50, 55, 60, 65, 70, 75, and 80 may be selected, as well as any intermediate value therebetween.

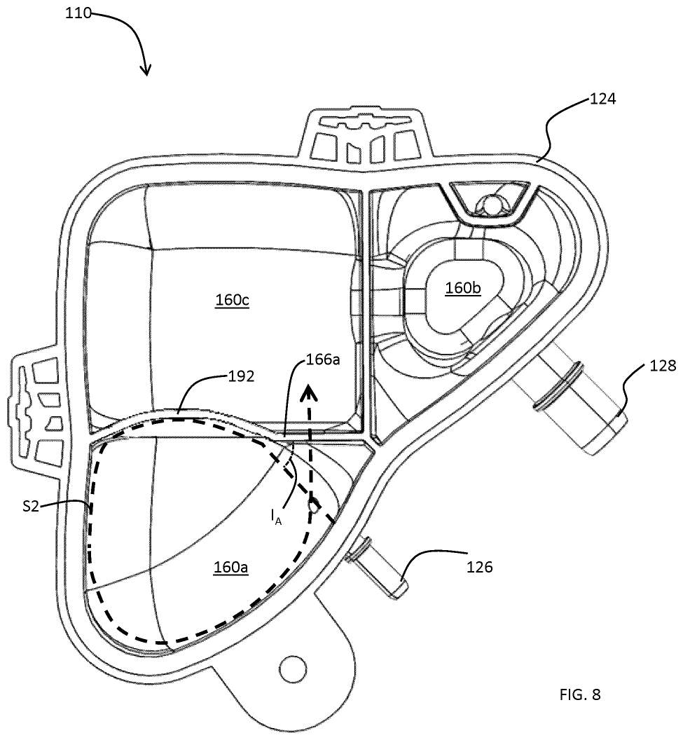

With reference now to FIG. 8, aspects of an alternative surge tank 110 will be discussed, with specific regard to differences in construction, and the flow of coolant therethrough. The alternative surge tank 110 is configured in much the same way as the surge tank 10, so only difference between the two are noted in the following discussion. Accordingly, similar components are identified by corresponding reference numerals increased by 100. Of particular note, the surge tank 110 includes a modified internal wall structure that delineates the input chamber 160a. Instead of a largely planar wall arrangement, the first interior wall segment 166 is shaped or contoured as shown, to promote the swirling action (noted by arrow S2) of the coolant inflow. The contour 192 is provided in the first interior wall segment 166, and may in some instances be formed in only the first interior wall segment 166a that is formed as part of the second tank portion 124. Aspects relating to the impingement angle IA remain the same as previous discussed relative to the surge tank 10, with the exception that the contour 192 initiates the swirling action, to promote the dissipation of energy, the separation of entrapped gases, and reduces the possibility of cavitation of the incoming coolant flow that could introduce additional gases into the liquid phase. Following this swirling action in the input chamber 160a, the coolant continues through the intermediate chamber 160c, and output chamber 160b as previously described.

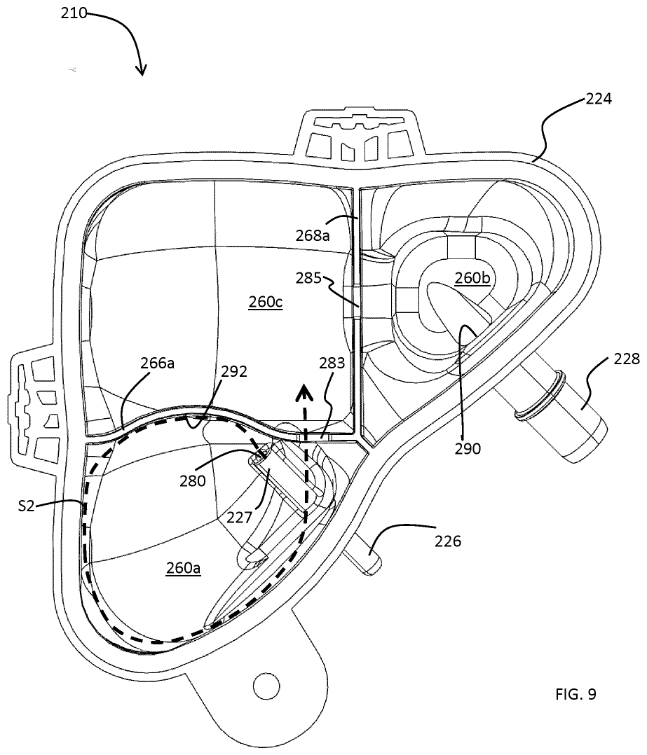

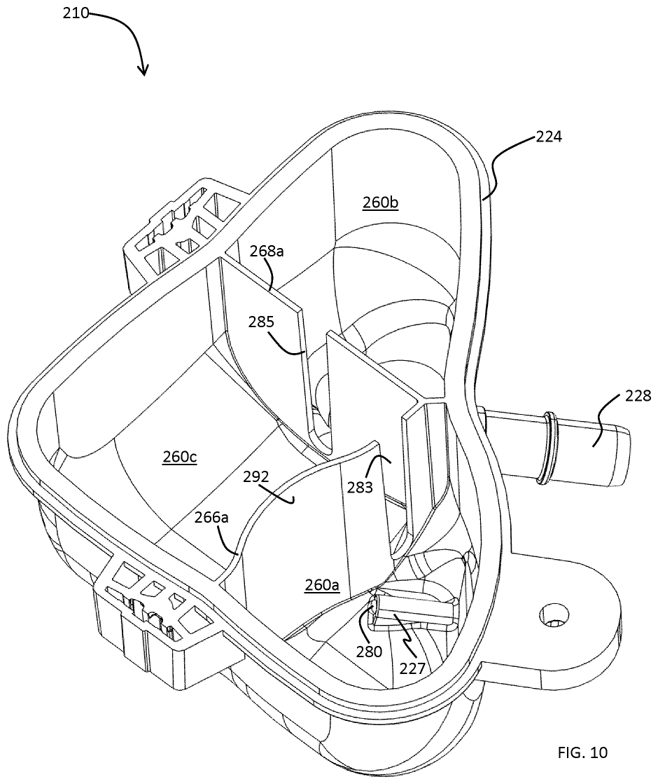

With reference now to FIGS. 9 and 10, aspects of an alternative surge tank 210 will be discussed, with specific regard to differences in construction, and the flow of coolant therethrough. The alternative surge tank 210 is configured in much the same way as the surge tank 110, so only difference between the two are noted in the following discussion. Accordingly, similar components are identified by corresponding reference numerals increased by 100. Of particular note, the surge tank 210 includes a modified inlet 226 having an inlet extension 227 that releases the incoming coolant in closer proximity to the contour 292 provided in the first interior wall segment 266. The surge tank 210 also provides an alternative fluid passage feature between the input chamber 260a, the intermediate chamber 260c, and the output chamber 260b. As shown, the input chamber 260a is configured to receive an inflow of coolant from the inlet 226 through an inlet port 280. The coolant circulates in the input chamber 260a, with a portion being discharged into the intermediate chamber 260c through a hole or slot provided in the first interior wall segment 266a. As shown, the first interior wall segment 266a includes a fluid passage slot 283. The coolant then circulates in the intermediate chamber 260c, with a portion being discharged into the output chamber 260b through a hole or slot provided in the second interior wall segment 268a. As shown, the second interior wall segment 268a includes a fluid passage slot 285. From the output chamber 260b, coolant is discharged back into the coolant loop via the outlet 228 through an outlet port 290.

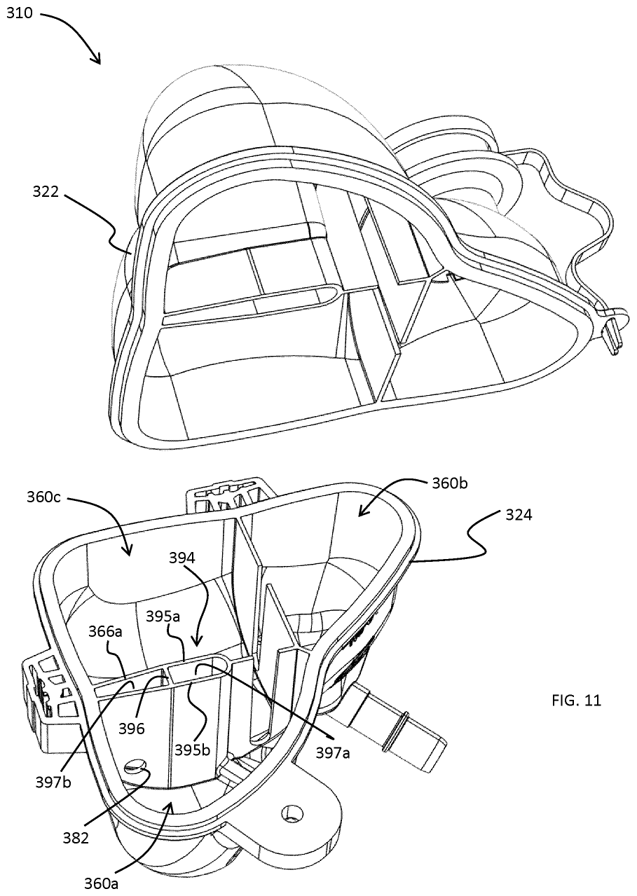

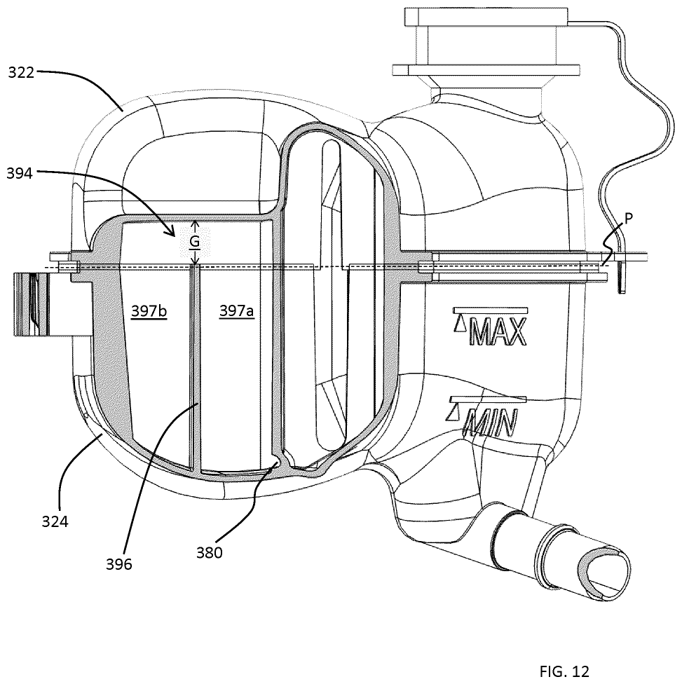

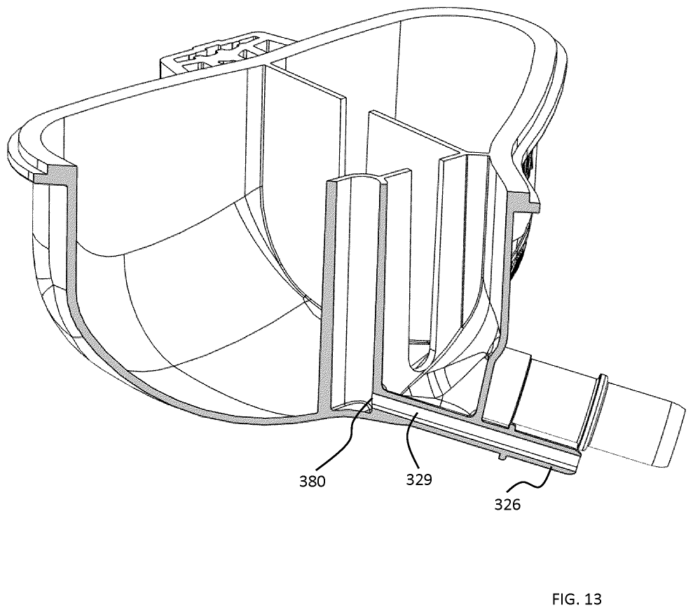

With reference now to FIGS. 11, 12 and 13, aspects of an alternative surge tank 310 will be discussed, with specific regard to differences in construction, and the flow of coolant therethrough. The alternative surge tank 310 is configured in much the same way as the surge tank 10, so only difference between the two are noted in the following discussion. Accordingly, similar components are identified by corresponding reference numerals increased by 300. Of particular note, the surge tank 310 includes an inlet sub-chamber 394 that receives coolant from an inlet port 380, that fluidly communicates with an inlet 326 through an intermediate inlet delivery conduit 329. The inlet sub-chamber 394 is built into the first interior wall segment 366a, with the provision of a first sub-chamber wall 395a and a second sub-chamber wall 395b, the first and second sub-chamber walls 395a, 395b being spaced apart, and configured to extend from a base region of the second tank portion 324, to a top region of the first tank portion 322. As shown, the first tank portion 322 may dimensioned/shaped with a depressed top region to join with the first and second sub-chamber walls 395a, 395b at a location that is above the assembly plane, but below the upper-most extent of the first tank portion 322.

The inlet sub-chamber 394 is further subdivided by a weir 396 into a first sub-chamber portion 397a and a second sub-chamber portion 397b. The weir 396 extends from the base region of the second tank portion 324 up to the assembly plane P, therein leaving a gap G that permits coolant to flow from the first sub-chamber portion 397a, which receives the initial incoming coolant from the inlet port 380, over to the second sub-chamber portion 397b. From the second sub-chamber portion 397b, the coolant flows through a fluid passage hole 382, into the input chamber 360a. From the input chamber 360a, the coolant continues through the intermediate chamber 360c, and output chamber 360b as previously described. With this construction, in addition to the movement and swirling action of the coolant through the various chambers 360a, 360c, 360b, the movement of the coolant through the inlet sub-chamber 394, in particular over the weir 396 is an additional means to promote the dissipation of energy and separation of entrapped gases from the coolant.

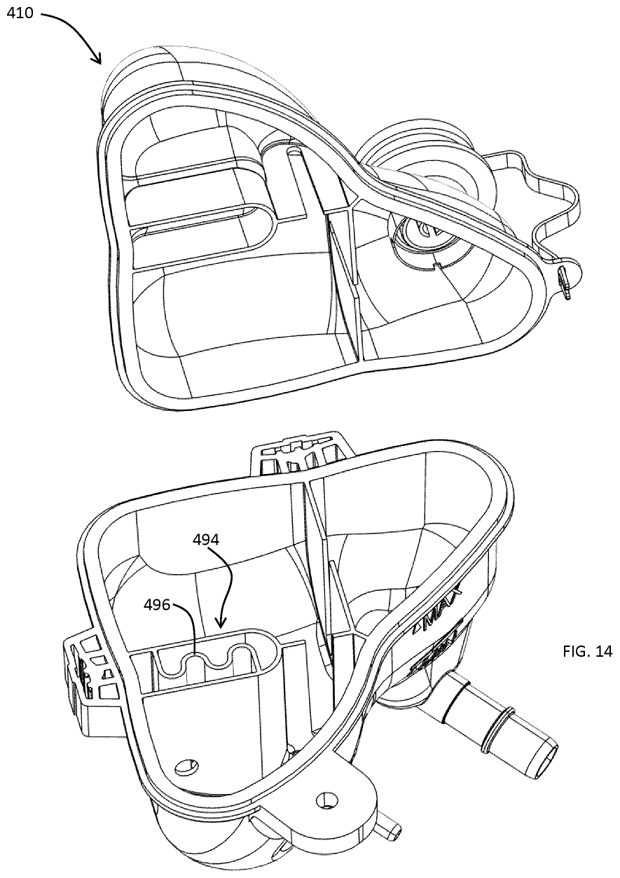

With reference now to FIG. 14, aspects of an alternative surge tank 410 will be discussed, with specific regard to differences in construction, and the flow of coolant therethrough. The alternative surge tank 410 is configured in much the same way as the surge tank 310, so only difference between the two are noted in the following discussion. Accordingly, similar components are identified by corresponding reference numerals increased by 100. Of particular note, the surge tank 410 includes an inlet sub-chamber 494 as detailed for the surge tank 310, with the exception that that weir 496 is provided in a serpentine configuration, to further promote the dissipation of energy and separation of entrapped gases from the coolant. All other aspects of the construction and coolant flow characteristics are as previously described having regard to the surge tank 310.

It will be appreciated that while the surge tanks have been exemplified as having an internal volume subdivided into 3 primary chambers, the noted aspects relating to the input (swirl) chamber may be applied in other configurations of surge tanks, where there are a lesser or greater number of chambers subdividing the internal volume.

The surge tanks disclosed herein may be made of any suitable thermoplastic, including but not limited to polypropylene, polyethylene, and polycarbonate. The thermoplastic may also include various fillers known in the art, including but not limited to mineral fillers (i.e. calcium carbonate, talc, etc.) as well as additives, including but not limited to fibrous additives (i.e. glass fibers, carbon fibers, etc.). The surge tanks as described herein may be injection molded, although alternative manufacturing methodologies may be suitably implemented to achieve the desired form. In some embodiments, the thermoplastic selected will be selected for a particular translucency/opacity characteristic.

The various embodiments described above have the particular advantage of avoiding the introduction of air into the closed fluid loop in the event the coolant flow reverses in direction, as may occasionally occur. With the configuration presented in embodiments 1, 2, and 3, the inlet port that releases the coolant into the input chamber is located below the minimum operable fluid level. As a result of this configuration, in the event of a temporary reversal in coolant flow in the closed fluid loop, the reverse draw on the surge tank will pull coolant instead of air through the inlet. With the configuration presented in embodiments 4 and 5, the sub-chambers that receive the incoming coolant from the respective inlet ports is a closed chamber, separated from the broader headspace of the input, intermediate and output chambers of the surge tank. While there is a headspace of air in the sub-chamber, a temporary reversal in coolant flow will generate a negative pressure in this headspace, therein causing coolant to flow in the opposite direction over the weir. As a result of this siphon effect, the reverse draw on the surge tank will pull only coolant instead of air through the inlet.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

What is claimed is:

1. An automotive surge tank, comprising:
a tank body defining an interior volume, the tank body including a first tank portion and a second tank portion; and
a coolant inlet and a coolant outlet provided on the tank body;
wherein the interior volume of the tank body is subdivided into an inlet chamber, and outlet chamber, and at least one intermediate chamber; and
wherein the coolant inlet directs an inflow of coolant into the inlet chamber at a level that is below the minimum operable fluid level of the surge tank.

2. The automotive surge tank according to claim 1, wherein each of the inlet chamber, the outlet chamber and the intermediate chamber are delineated by at least a portion of an interior wall structure, wherein the inlet chamber is separated at least in part from the intermediate chamber by a first wall segment, and wherein the intermediate chamber is separated at least in part from the outlet chamber by a second wall segment.

3. The automotive surge tank according to claim 2, wherein each of the first and second wall segments include a fluid passage hole that permits coolant to flow from the inlet chamber through to the outlet chamber via the intermediate chamber.

4. The automotive surge tank according to claim 2, wherein the inlet is arranged to deliver an incoming coolant stream at an impingement angle relative to the first wall segment.

5. The automotive surge tank according to claim 4, wherein the impingement angle is between 20 to 80°.

6. The automotive surge tank according to claim 4, wherein the impingement angle is approximately 45°.

7. The automotive surge tank according to claim 2, wherein the first wall segment is presented in a largely planar wall structure.

8. The automotive surge tank according to claim 2, wherein the first wall segment is presented with a contoured surface to promote a swirling action of the coolant upon impingement.

9. The automotive surge tank according to claim 8, further comprising an inlet extension that extends from the inlet within the inlet chamber, the inlet extension serving to release incoming coolant in closer proximity to the contoured surface provided in the first wall segment.

10. An automotive surge tank, comprising:
a tank body defining an interior volume, the tank body including a first tank portion and a second tank portion; and
a coolant inlet and a coolant outlet provided on the tank body;
wherein the interior volume of the tank body is subdivided into an input chamber, and output chamber, and at least one intermediate chamber; and
wherein the coolant inlet directs an inflow of coolant into an inlet sub-chamber below the minimum operable fluid level.

11. The automotive surge tank according to claim 10, wherein the inlet sub-chamber receives coolant from an inlet port that fluidly communicates with the coolant inlet through an intermediate inlet delivery conduit.

12. The automotive surge tank according to claim 10, wherein the inlet sub-chamber is defined by a first sub-chamber wall and a second sub-chamber wall, where the first and second sub-chamber walls are arranged in spaced-apart relationship and collectively define a first interior wall segment that at least in part separates the input chamber from the intermediate chamber, and wherein the intermediate chamber is separated at least in part from the output chamber by a second wall segment.

13. The automotive surge tank according to claim 12, wherein the inlet sub-chamber is subdivided by a weir into a first sub-chamber portion and a second sub-chamber portion, and wherein the inflow of coolant is first received within the first sub-chamber portion, flows over the weir into the second sub-chamber portion, the second sub-chamber portion having a fluid passage hole to then discharge the coolant into the input chamber.

14. The automotive surge tank according to claim 13, wherein the weir is provided in a serpentine configuration.
